(19) United States
(12) Patent Application Publication
(10) Pub. No.: US 2005/0269945 A1
(43) Pub. Date: Dec. 8, 2005

(54) Organic light-emmitting display panel and method of manufacturing the same

(75) Inventor: Chih-Hung Su, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/006,261

(22) Filed: Dec. 7, 2004

(30) Foreign Application Priority Data
Jun. 3, 2004 (TW) 93116027

(51) Int. Cl. H01J 1/62

(52) U.S. Cl. 313/504

(57) ABSTRACT

An organic light-emitting display (OLED) includes a substrate and several organic light-emitting display panels. Each organic light-emitting display panel includes a thin film transistor (TFT), an anode, an organic light-emitting structure, a cathode and a bus line. The TFT is disposed on the substrate, and the anode is disposed on the TFT and the substrate. The cathode is disposed on the organic light-emitting structure. The bus line is electrically connected to the cathode for suppressing an increase in wiring resistance of the cathode.

This application claims the benefit of Taiwan Patent Application Serial No. 93116027, filed Jun. 3, 2004, the subject matter of which is incorporated herein by reference.

### BACKGROUND OF THE INVENTION

1. Field of the Invention

The invention relates in general to a display, and more particularly to an organic light-emitting display.

2. Description of the Related Art

Organic electroluminescent devices, such as organic light-emitting displays (OLEDs), have been popularly applied to various flat displays because such advantages of self-emission, very thin form factor, high luminance, high luminous efficiency, high contrast, fast response time, wide viewing angle, low power consumption, wide operating temperature range, and potential of flexible substrate.

Referring to FIG. 1, it is a schematic view of a conventional bottom emission organic light-emitting display. A bottom emission organic light-emitting display 10 includes a substrate 11, a thin film transistor (TFT) 12, a protecting layer 13, an anode 15, an organic emissive layer 16, a cathode 17, and a partition 18. The anode 15 is such an indium tin oxide (ITO) electrode and the substrate 11 is such a transparent glass substrate. In the bottom emission organic light-emitting display 10, light emitted from a light-emitting layer 15, along the direction of the arrow a in FIG. 1, passes through an anode 15 and the substrate 11. Owing to the limitation of the light-emitting direction, light has to pass through the substrate 11 with several modules so that the aperture ratio of the bottom emission organic light-emitting display 10 is low.

Therefore, a top emission organic light-emitting display aims to increase the aperture ratio of the organic light-emitting display by enforcing light to pass through the cathode and the partition. However, the materials of the cathode applied to the top emission organic light-emitting display and the required manufacturing method have not developed well. For example, considering the work function, aluminum is the best choice to be applied to the organic light-emitting display, but the metal is not pervious to light. Once a metal layer with very thin thickness is applied to the organic light-emitting display, high impedance of the thin metal layer brings serious voltage problem and the displaying quality of OLEDs is greatly affected.

### SUMMARY OF THE INVENTION

It is therefore an object of the invention to provide an organic light-emitting display panel and a manufacturing method thereof. The organic light-emitting display panel of the present invention can dissolve the voltage problem effectively and be suitable to both top emission and bottom emission OLED to improve the displaying quality thereof.

The invention achieves the above-identified object by providing an organic light-emitting display panel. The organic light-emitting display panel includes a thin film transistor (TFT), an anode, an organic light-emitting structure, a cathode and a bus line. The TFT is disposed on the substrate, and the anode is disposed on the substrate and electrically connected to the TFT. The organic light-emitting structure is disposed on the anode. The cathode is disposed on the organic light-emitting structure. The bus line disposed on the cathode and is electrically connected to the cathode for suppressing an increase in wiring resistance of the cathode.

Also, the invention achieves the above-identified object by providing a method of manufacturing an organic light-emitting display panel comprising: providing a substrate; forming an anode on the substrate; forming an organic light-emitting structure on the anode; forming a cathode on the organic light-emitting structure; and forming a bus line over the substrate and electically connected to the cathode.

In practically, the bus line electrically connected to the cathode could be made in many different ways. For example, the bus line could be formed right on the cathode. Given another example, the bus line could be formed under the cathode as stated below. After forming the anode, a passivation layer is formed on the lateral side of the anode and covering part of the anode, wherein the bus line is disposed right on the passivation layer. Forming the organic light-emitting structure by the lateral side of the bus line, the cathode is formed on the bus line and the organic light-emitting structure. That is, the bus line is disposed under the cathode and electrically connected to the cathode.

Other objects, features, and advantages of the invention will be apparent in the following detailed description of the preferred but non-limiting embodiments. The following description is made with reference to the accompanying drawings.

### BRIEF DESCRIPTION OF THE DRAWINGS

FIG. 1 is a schematic view of a conventional bottom emission organic light-emitting display.

FIG. 2 is a lateral view of an organic light-emitting display panel according to the first embodiment of the invention.

FIG. 3 is a lateral view of an organic light-emitting display panel according to the second embodiment of the invention.

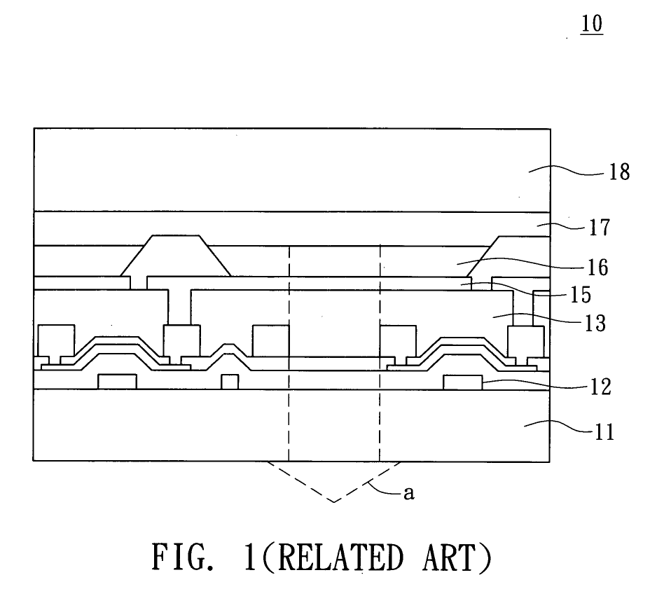

### DETAILED DESCRIPTION OF THE INVENTION

The concept of the present invention is that setting a bus line to electrically connect to the cathode for suppressing an increase in wiring resistance of the cathode and improving the displaying quality of the OLED. In the following embodiments, a top emission organic light-emitting display is taken for an example; however, the present invention is not limited thereto. For example, the present invention is also suitable for a bottom emission organic light-emitting display or other related display apparatuses.

The organic light-emitting display (OLED) of the present invention includes a substrate and several organic light-emitting display panels. Each organic light-emitting display panel includes a thin film transistor (TFT), an anode, an organic light-emitting structure, a cathode and a bus line. The TFT is disposed on the substrate, and the anode is disposed on the substrate and electrically connected to the TFT. The organic light-emitting structure is disposed on the anode. The organic light-emitting structure includes a hole transporting layer (HTL) disposed on the anode, an emitting layer (EL) formed on the HTL, and an electron transport layer (ETL) formed on the EL. The cathode is disposed on the organic light-emitting structure and electrically connected to the ETL. The bus line is electrically connected to the cathode for suppressing an increase in wiring resistance of the cathode.

### First Embodiment

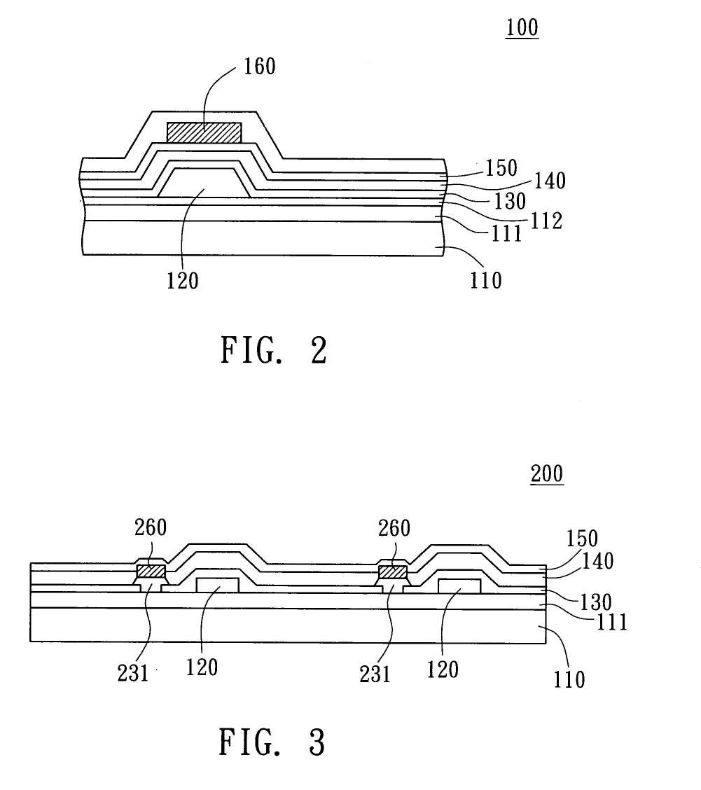

Referring to FIG. 2 it is a lateral view of an organic light-emitting display panel according to the first embodiment of the present invention. In an organic light-emitting display panel 100, a reflecting layer 111 is formed on a substrate 100, a protecting layer 112 is formed on the reflecting layer 111, and a thin film transistor (TFT) 120 is formed on the protecting layer 112. An organic light-emitting structure 140 is formed on the anode 130 disposed on the protecting layer 112 and electrically connected to the TFT 120, and the cathode 150 is disposed on the organic light-emitting structure 140. The organic light-emitting structure 140 includes a hole transporting layer (HTL) disposed on the anode, an emitting layer (EL) formed on the HTL, and an electron transport layer (ETL) formed on the EL. The bus line 160 is formed on the cathode 150 and is electrically connected to the cathode 150 for suppressing an increase in wiring resistance of the cathode 150.

The cathode 150 contains a material pervious to light, such as a thin film metal layer, an indium tin oxide (ITO) layer or a combination thereof. Also, the cathode 150 has the thickness of several angstroms (Å) to allow light pass through, so that light emitted from the organic light-emitting structure 140 is reflected by the reflecting layer 111 and passes through the cathode 150.

The bus line 160 is a thick metal layer, preferably, the thickness of which is between about 1000 Å and 2 μm. Beside, the bus line 160 contains a metal with low resistance, such as aluminum, silver, and so on.

The TFT 120 covers parts of the reflecting layer 111 to form a shelter region and the bus line 160 is disposed over the shelter region with respect to the TFT 120. As a result, although the bus line 160 on the cathode 150 is not pervious to light, the aperture ratio of the organic light-emitting display panel 100 is still maintained and the bus line 160 also prevents interference from two adjacent organic light-emitting display panels.

In practice, the manufacturing method of an organic light-emitting display panel 100 includes the steps of: providing a substrate 110; forming a reflecting layer 111 on the substrate 110; forming a protecting layer 112 on the reflecting layer 111; forming a thin film transistor (TFT) 120 on the protecting layer 112; forming an anode 130 on the protecting layer 112; forming an organic light-emitting structure 140 on the anode 130; forming a cathode 150 on the organic light-emitting structure 140; and forming a bus line 160 on the cathode 150 and the TFT 120.

### Second Embodiment

Some elements of the organic light-emitting display panel and those of the organic light-emitting display panel 100 in FIG. 2 are the same, even though the relative position and the manufacturing method in the second embodiment are different. The same label numbers will be used to the corresponding elements in the second embodiment, such as the substrate 110, TFT 120, organic light-emitting structure 140, and the cathode 150.

Referring to FIG. 3, it is a lateral view of an organic light-emitting display panel according to the second embodiment of the present invention. In an organic light-emitting display panel 200, a passiviation layer 231 is disposed between two adjacent organic light-emitting display panels, on the lateral side of the anode 130, and covering part of the anode 130. Bus line 260 is disposed on the passivation layer 231, and electrically disconnected to the anode 130. Also, the bus line 260 is disposed on a lateral side of the organic light-emitting structure 140. Besides, the bus line 260 can be taken as a black matrix to prevent RGB mix and the contrast will rise.

Further, in practice, the method of manufacturing an organic light-emitting display panel 200 includes: providing a substrate 110; forming a reflecting layer 111 on the substrate 110; forming a thin film transistor (TFT) 120 on the substrate 110; forming an anode 130 on the substrate and electrically connected to the TFT 120; forming a passiviation layer 231 disposed on the reflecting layer 111 and between two adjacent organic light-emitting display panels and covering part of the anode 130; forming a bus line 260 on the passivation layer 231 and near a lateral side of the anode 130 but not being electrically connected to the anode 130; forming an organic light-emitting structure 140 on the anode 130; forming a cathode 150 on the organic light-emitting structure 140 and electrically connecting the bus line 260. The cathode 150 is for suppressing an increase in wiring resistance of the cathode 150; The step of forming an organic light-emitting structure 140 includes: forming a hole transporting layer (HTL) on the anode 130; forming an emitting layer (EL) on the HTL; and forming an electron transport layer (ETL) on the EL.

The organic light-emitting display panels 100, 200 of the preferred embodiments of the present invention uses a thin film metal with a bus line as the cathode to provide various advantages such as high aperture ratio, complementary work functions, low impedance, and so on. Because the bus line can suppress an increase in wiring resistance of the cathode effectively, the required thickness of the panel is reduced and the brightness can be enhanced. Also, the materials of the cathode are not limited to the transparent ones as before, like a metal layer with very thin thickness being suitable to be a cathode. Moreover, metal has additional advantage of flexibility of being applied to the organic light-emitting structure although metal is not pervious to light, light still passes there through when the metal layer has very thin thickness.

Further, using a cathode with low resistance and good work function can dissolve the voltage problem effectively and improve the displaying quality of OLEDs. In addition, the method disclosed in the second embodiment is not complex comparing to conventional one, and only one step is additive. As the result, the method disclosed in the second embodiment is economic and easily accomplished. Also, the method disclosed in the first embodiment retrenches using of precise photo masks so that the production cost and time can be reduced.

While the invention has been described by way of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An organic light-emitting display panel comprising:
a substrate;
a thin film transistor (TFT) disposed on the substrate;
an anode disposed on the substrate and electrically connected to the TFT;
an organic light-emitting structure disposed on the anode;
a cathode disposed on the organic light-emitting structure; and
a bus line disposed over the substrate and electrically connected to the cathode.

2. The panel according to claim 1, wherein the bus line is disposed on the cathode.

3. The panel according to claim 1, further comprising a reflecting layer disposed between the TFT and the substrate.

4. The panel according to claim 1, further comprising a passivation layer disposed over the substrate, wherein the bus line is disposed on the passivation layer and positioned under the cathode.

5. The panel according to claim 4, further comprising a reflective layer formed on the substrate, wherein the passivation layer is disposed on the reflecting layer.

6. The panel according to claim 1, wherein the organic light-emitting structure comprises a hole transporting layer (HTL) dispose on the anode, an emitting layer (EML) disposed on the HTL, and an electron transporting layer (ETL) disposed on the EML and positioned under the cathode.

7. The panel according to claim 1, wherein the cathode includes a thin film metal layer.

8. The panel according to claim 5, wherein the cathode comprises indium tin oxide (ITO).

9. The panel according to claim 1, wherein the cathode comprises an indium tin oxide (ITO).

10. The panel according to claim 1, wherein the bus line comprises a metal layer.

11. The panel according to claim 1, wherein the thickness of the bus line is between about 1000 Å and 2 μm.

12. The panel according to claim 1, wherein the bus line comprises aluminum.

13. The panel according to claim 1, wherein the bus line comprises silver.

14. A method of manufacturing an organic light-emitting display panel, comprising:
providing a substrate;
forming a thin film transistor (TFT) on the substrate;
forming an anode on the substrate and electrically connected to the TFT;
forming an organic light-emitting structure on the anode;
forming a cathode on the organic light-emitting structure; and
forming a bus line over the substrate and electrically connected to the cathode.

15. The method according to claim 14, further comprising forming a protecting layer on the substrate.

16. The method according to claim 14, further comprising forming a reflecting layer on the substrate.

17. The method according to claim 14, further comprising forming a passivation layer on the lateral side of the anode to cover part of the anode.

18. The method according to claim 17, wherein forming the bus line over the substrate comprises forming the bus line on the passivation layer.

19. The method according to claim 14, wherein forming the organic light-emitting structure on the anode comprises:
forming a hole transporting layer (HTL) on the anode;
forming an emitting layer (EL) on the HTL; and
forming an electron transport layer (ETL) on the EL.

20. The method according to claim 14, wherein forming the bus line over the substrate comprises forming the bus line on the cathode.
